(19) United States
(12) Patent Application Publication
(10) Pub. No.: US 2025/0062365 A1
(43) Pub. Date: Feb. 20, 2025

(54) SUBSTRATES, OXYGEN ELECTRODES AND ELECTROCHEMICAL DEVICES

(71) Applicant: HYDROLITE LTD, Caesarea (IL)

(72) Inventors: Anna KITAYEV, Rosh Ha Ayin (IL); Ervin TAL-GUTELMACHER, Hod Hasharon (IL); Charly David AZRA, Harish (IL); Viktoria SMIRNOVA, Zichron Yaakov (IL)

(73) Assignee: HYDROLITE LTD, Caesarea (IL)

(21) Appl. No.: 18/795,323

(22) Filed: Aug. 6, 2024

Related U.S. Application Data
(60) Provisional application No. 63/532,752, filed on Aug. 15, 2023.

(51) Int. Cl. H01M 4/88; C25B 9/23; C25B 11/032; C25B 11/056; C25B 11/063; H01M 4/86; H01M 8/0232; H01M 8/0245

(52) U.S. Cl. CPC H01M 4/8807; C25B 9/23; C25B 11/032; C25B 11/056; C25B 11/063; H01M 4/8621; H01M 4/8817; H01M 8/0232; H01M 8/0245

(57) ABSTRACT

Substrates for producing oxygen electrodes, oxygen electrodes, electrochemical devices and productions methods are provided. Substrates include an intermediate microporous layer (MPL) attached to a porous transport layer (PTL) to interface between the PTL and the catalytic layer deposited on the MPL—to provide microstructure compatibility, improved adhesion and better performance of the oxygen electrode produced therefrom. The MPL corresponds to the PTL with respect to the types of metallic material, to provide good electric conductivity, while the metal particle sizes of the MPL are selected to modify the pore sizes of the PTL to reach a predefined pore size distribution of the substrate—which best supports printing, adhesion and performance of the catalyst layer on the substrate. Electrochemical devices such as fuel cells, electrolyzers and reversible devices may include the oxygen electrodes, which may be optimized for the specific application.

### CROSS REFERENCE TO RELATED APPLICATIONS

This application claims priority from U.S. Provisional Application No. 63/532,752, filed on Aug. 15, 2023, which is incorporated herein by reference in its entirety.

### BACKGROUND OF THE INVENTION

### 1. Technical Field

The present invention relates to the field of electrochemical devices, and more particularly, to oxygen electrodes and substrates for their production.

### 2. Discussion of Related Art

Intensive research is conducted in the field of electrochemical devices towards developing and improving fuel cells and electrolyzers. A crucial component in these is the oxygen electrode, which catalyzes oxygen reduction and oxygen generation, respectively, in these devices.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a substrate for producing an oxygen electrode, the substrate comprising a porous transport layer (PTL) made of metal fibers comprising at least one of nickel, stainless steel, titanium, alloys thereof or combinations thereof, and a microporous layer (MPL) made of a similar metal as the PTL, attached to the PTL to provide electric conductivity thereto, and to yield a predefined pore size distribution of the substrate.

One aspect of the present invention provides oxygen electrodes produced with the disclosed substrates, and electrochemical devices such as fuel cells, electrolyzers and/or reversible devices that use the provided oxygen electrodes.

One aspect of the present invention provides a method comprising producing a substrate for an oxygen electrode by attaching a microporous layer (MPL) onto a porous transport layer (PTL), wherein the MPL is made of a similar metal as the PTL to provide electric conductivity thereto, and wherein the MPL has a predefined pore size distribution.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic illustration of a substrate and the producing therefrom of an oxygen electrode therefrom, according to some embodiments of the invention.

FIG. 2 is a high-level schematic illustration of electrochemical devices comprising the oxygen electrode, according to some embodiments of the invention.

FIG. 3 provides a light microscope image of a substrate comprising the MPL attached to the PTL, according to some embodiments of the invention.

FIG. 4 provides results of testing the oxygen electrode in a fuel cell configuration, according to some embodiments of the invention.

FIG. 5 is a high-level flowchart illustrating production methods, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for producing substrates of oxygen electrodes and thereby provide improvements to the technological field of electrochemical devices. Substrates for producing oxygen electrodes, oxygen electrodes, electrochemical devices and productions methods are provided. Substrates include an intermediate microporous layer (MPL) attached to a porous transport layer (PTL) to interface between the PTL and the catalytic layer deposited on the MPL—to provide microstructure compatibility, improved adhesion and better performance of the oxygen electrode produced therefrom. The MPL corresponds to the PTL with respect to the types of metallic material, to provide good electric conductivity, while the metal particle sizes of the MPL are selected to modify the pore sizes of the PTL to reach a predefined pore size distribution of the substrate-which best supports printing, adhesion and performance of the catalyst layer on the substrate. Additional advantages of using disclosed MPL includes the improvement (reduction) of the electrode's contact resistance, and mechanical protection of the membrane from perforation by PTL fibers. Electrochemical devices such as fuel cells, electrolyzers and reversible devices may include the oxygen electrodes, which may be optimized for the specific application.

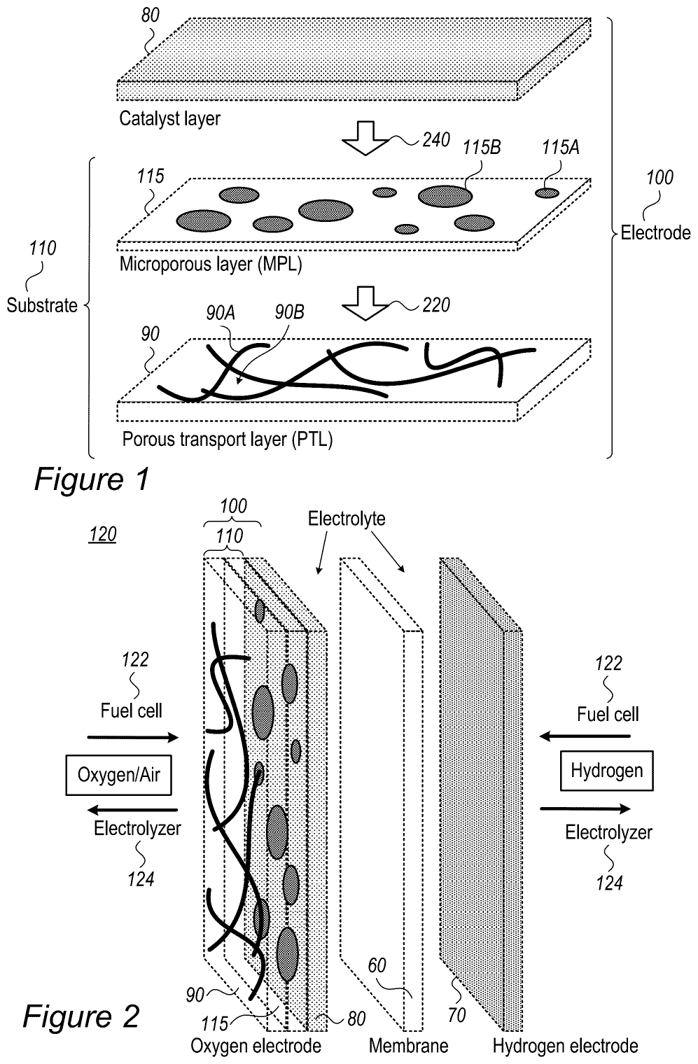

FIG. 1 is a high-level schematic illustration of a substrate 110 and the producing therefrom of an oxygen electrode 100, according to some embodiments of the invention. Substrate 110 comprises a porous transport layer (PTL) 90 made of metal fibers 90A with intermediate openings 90B (illustrated in a highly schematic and magnified manner), that may be made of, or comprise, e.g., nickel, stainless steel, titanium, alloys thereof and/or combinations thereof, and a microporous layer (MPL) 115 made of a similar metal as PTL 90 (e.g., nickel, stainless steel, titanium, alloys thereof and/or combinations thereof, also termed GDL for gas diffusion layer). For example, MPL 115 may comprise metal microparticles and polymer, e.g., with the microparticles embedded in the polymer as binding material and have a specified size distribution and density. The polymers used for MPL 115 may be of any type, such as polymer binders disclosed herein, and may have any compatible distribution of molecular weights and particles sizes, with a chemistry that is stable in high pH electrolyte.

MPL 115 is attached to PTL 90 (denoted schematically by arrow 220) to provide electric conductivity to PTL 90 and consequently to substrate 110 as a whole. Substrate 110 has a predefined pore size distribution that results from the overlapping of the one or more metal particle sizes of MPL 115 over the multiple pore sizes of PTL 90. In the highly schematic and magnified illustration of FIG. 1, multiple particle sizes are shown (e.g., 115A, 115B). Particle sizes in MPL 115 may range from sub-microns (e.g., tens and/or hundreds of nm) to hundreds of microns. The particle size distribution in MPL 115 may be selected and configured with respect to the pore size distribution (resulting, e.g., from the dimensions, shape and density of fibers 90A)—to yield the predefined pore size distribution of substrate 110. For example, the porosity of PTL 90 may range between 10% and 90% (v/v) (e.g., be within 10-90%, 20-80%, 30-70%, or within any intermediate ranges or values) with pore sizes typically larger than one micron (1 μm). The metal particle sizes in MPL 115 may be between 100 nm and 500 μm (e.g., be within 0.1-1 μm, 0.1-10 μm, 1-10 μm, 1-100 μm, 10-100 μm, 10-500 μm, or within any intermediate ranges or values). The metal particle sizes in MPL 115 may have one or several specific distinct values or may be distributed within a range of sizes in a specified distribution.

In addition to the electric conductivity and the predefined pore size distribution of the substrate, attaching MPL 115 to PTL 90 may also improve (reduce) the contact resistance of electrode 100, and protect membrane 60 (see FIG. 2 below) from the hazard of being perforated by PTL fibers.

Prior to the attachment of MPL 115 onto PTL 90, PTL 90 may be pretreated by various techniques, such as chemical pretreatment (e.g., using acid), pretreatment by applying plasma, corona pretreatment, electrochemical pretreatment and/or mechanical pretreatment.

MPL 115 may be attached to PTL 90 using various methods such as printing, deposition or spraying (e.g., ultrasonic spaying or even manual spraying), transferring (e.g., screen printing), or other attachment methods. For example, MPL 115 may be printed or sprayed onto PTL 90, with MPL 115 including one or more types and/or sizes of metal particles, one or more polymer binder and using one or more solvent allowing optimal printing process (e.g., ethanol, propanol or other alcohols, water, acetates, etc.).

In various embodiments, MPL 115 may comprise one or more polymer binder used as a solution, a dispersion or an emulsion. Non-limiting examples for binders include any of: Low-density polyethylene (LDPE), linear low-density polyethylene (LLDPE), high density polyethylene (HDPE), ultra-high molecular weight polyethylene (UHMWPE), polypropylene, cyclic olefin polymers (COP), cyclic olefin copolymers (COC), cyclic block copolymers (CBC), styrene-butylene-ethylene-butylene (SEBS), SEBS grafted with maleic anhydride (SEBS-g-MA), SEBS grafted with amine (SEBS-g-amine), styrene-butadiene-styrene (SBS), styrene-butadiene-butylene-styrene (SBBS), polyvinyl butyral (PVB), fluorinated polymers such as polytetrafluoroethylene (PTFE), polyurethane (PU), polyether ether ketone (PEEK) and/or polyphenylene sulfide (PPS). In various embodiments, MPL 115 may comprise anion-exchange resins such as polyvinyl benzyl chloride (PVBC), styrene-vinyl benzyl chloride copolymer and/or poly aryl piperidinium (PAP).

MPL 115 may also comprise pore forming agents, such as propylene carbonate. Alternatively, MPL 115 may be deposited on PTL 90 by producing MPL 115 as a separate layer, or by producing MPL 115 on a separate substrate by any of the disclosed methods (e.g., printing, spraying, or using any other deposition method) and transferring the prepared MPL 115 from the separate substrate transfer onto PTL 90.

Optionally, hot pressing of substrate 110 (including MPL 115 attached to PTL 90) may be applied to improve adhesion and mechanical and electric properties of substrate 110. For example, hot pressing may be carried out at temperatures of several hundred degrees, e.g., between 100° C. and up to 1200° C. (e.g., at any subrange thereof, e.g., at several hundred degrees), at pressures of several to tens of ton/cm², e.g., between 1 and 50 ton/cm² and for brief time periods, depending on the process conditions.

Optionally, substrate 110 (including MPL 115 attached to PTL 90) may be calendared and/or roll-pressed to improve adhesion and mechanical and electric properties of substrate 110. In various embodiments, substrate 110 may be post-treated to eliminate a passivated layer from the metal, to remove pore forming components from MPL 115, to adhere MPL 115 to PTL 90 and/or to stabilize MPL 115 components within the layer (e.g., particles 115A, 115B). After the attachment of MPL 115 onto PTL 90, MPL 115 may be post-treated, e.g., chemically, to remove (e.g., wash or dissolve) or modify components of MPL 115. In some embodiments, post-treatment may be applied by sintering of the binder, hot pressing and/or calendaring, as non-limiting examples.

Certain embodiments comprise oxygen electrode 100 comprising catalyst material 80 (illustrated schematically) deposited on MPL 115 of substrate 110 (denoted schematically by arrow 240). Advantageously, adjustment of the predefined pore size distribution of substrate 110 through the deposition of MPL 115 onto PTL 90 improves the adhesion and long-term performance of oxygen electrode 100 compared to direct deposition of catalyst material 80 onto PTL 90. Moreover, the metal particles of MPL 115 are stable to oxidation in high voltages required for electrolysis, which in turn makes also fuel cell performance stable. In addition, MPL 115 is configured to improve and/or support the distribution of oxygen, water and electrolyte to and from the catalyst material layer by regulation of the pore size distribution to the predefined optimal distribution and/or by varying the chemical components of substrate 110 (with respect to PTL 90 only) to control the surface energy.

MPL 115 may be configured to provide good electric conductivity to substrate 110 (e.g., with conductivity σ ranging, e.g., between 1.25 S/m and 6.4·10⁷ S/m at 20° C., or within any subranges thereof, e.g., 10-100 S/m, 100-1000 S/m, 10³-10⁴ S/m, 10⁴-10⁵ S/m, 10⁵-10⁶ S/m, 10⁶-10⁷ S/m pr even higher), good adhesion to and stability on PTL 90 (e.g., withstanding a tape test or equivalent separation tests), and layer characteristics (e.g., reaching porosity values of substrate 110 that are smaller than the PTL porosity, e.g. 1-10% v/v for low porosity PTLs, or 10-50% v/v for high porosity PTLs; and providing specified hydrophobicity values on the MPL side, e.g., a contact angle between 5° and 175°, e.g., between 10-50°, 40-90°, 80-140°, 130-170°, or intermediate values)—that allow for ink deposition of catalyst material 80 without decreasing the performance of electrochemical device 120. The ink solvent for catalyst material 80 may be any solvent (e.g., ethanol, propanol or other alcohols, water, acetates, etc.) that optimizes the printing process. It is noted that MPL 115 may provide coverage of PTL 90 that decreases the porosity of the PTL in a uniform manner). For example, the particle size distribution in MPL 115 may be selected to block large pores in PTL 90 and/or reduce their sizes to reach the predefined pore size distribution of substrate 110 and improve adhesion of catalyst material 80 thereto, while maintaining the rheological requirements from oxygen electrode 100

FIG. 2 is a high-level schematic illustration of electrochemical devices 120 comprising oxygen electrode 100, according to some embodiments of the invention. Oxygen electrode 100 is illustrated schematically as comprising PTL 90, MPL 115 (attached together as substrate 110) and catalyst material 80. Various electrochemical devices 120 may comprise oxygen electrode 100, e.g., with corresponding hydrogen electrode 70, membrane 60 and electrolyte (e.g., membrane separator and liquid electrolyte, or optionally a solid electrolyte separator), for example, a fuel cell 122, an electrolyzer 124 and/or a reversible device, configured to operate alternately as fuel cell 122 and as electrolyzer 124—in any of which oxygen electrode 100 being configured to catalyze the oxygen consuming and/or producing reactions (in fuel cell and electrolyzer modes, respectively) and hydrogen electrode 70 being configured to catalyze the hydrogen consuming and/or producing reactions (in fuel cell and electrolyzer modes, respectively). Catalyst material 80 may be selected according to the type of electrochemical device 120, e.g., single functional corresponding catalyst material 80 in either fuel cell 122 or electrolyzer 124, or bi-functional catalyst material 80 for reversible devices. Oxygen electrode 100 may be configured to function in AEM (anion exchange membrane) and/or PEM (proton exchange membrane) electrochemical devices 120.

Advantageously, the use of MPL 115 as an intermediate layer between PTL 90 and catalyst material 80 provides multiple benefits, such as: (i) allowing scaling up and mass production of electrodes 100 prepared by printing of catalyst layer 80 on PTL 90—e.g., in an adhesive production process over a large active area, (ii) protecting membrane 60 supporting catalyst layer 80 from perforation by PTL fibers 90A, and thereby preventing holes and gas crossover from one side of membrane 60 to its other side, (iii) regulating mass transport of liquids and/or gases across the membrane electrode assembly (MEA, comprising oxygen electrode 100, membrane 60 and/or electrolyte, and hydrogen electrode 70) by introducing functionality and pore size control by adjusting the configuration of MPL 115, and/or (iv) optimizing the distribution of oxygen across and over oxygen electrode 100—reducing the required flow rates of oxygen in fuel cell mode 122.

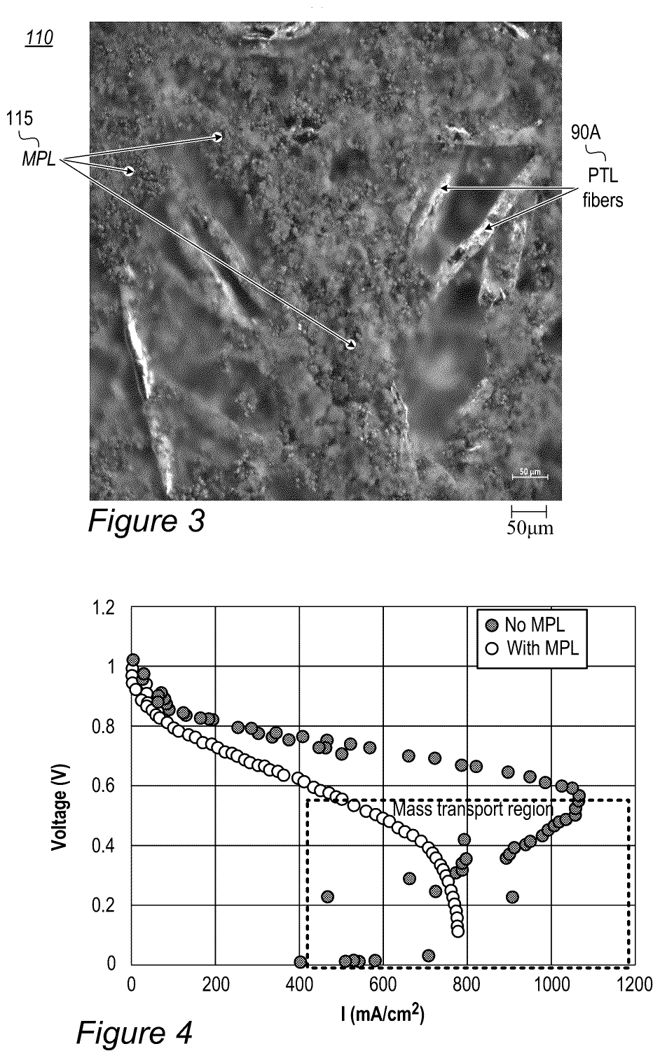

FIG. 3 provides a light microscope image of substrate 110 comprising MPL 115 attached to PTL 90, according to some embodiments of the invention. FIG. 3 illustrates partial coverage of MPL 115 on PTL 90 and coating of PTL fibers 90A by MPL material (with Ni particles sticking to the PTL fibers through the PTFE particles, and after hot press processing), reducing the pore sizes, coating the fibers to prevent damage to catalyst layer 80, and providing better adhesions and surface uniformity for application of catalyst layer 80 onto substrate 110 to form oxygen electrode 100. In the non-limiting example, MPL 115 comprises Ni microparticles mixed with PTFE (polytetrafluoroethylene) and/or polymer in ethanol, to form slurry which was printed directly on top of PTL 90.

FIG. 4 provides results of testing oxygen electrode 100 in fuel cell configuration 122, according to some embodiments of the invention. The test compared oxygen electrode 100 with and without MPL 115 and provides polarization curves of corresponding cells, indicating higher stability of the current in the mass transport region (see annotation in FIG. 4, as a non-limiting example) in cells with oxygen electrode 100 that include MPL 115. For example, the monotonous polarization curve with MPL 115 is an indication for the current stability of the oxygen electrode, as, e.g., a current density of 700 mA/cm² was measured only at 0.4V for the oxygen electrode with MPL 115, while the current density of 700 mA/cm² was measured at multiple voltage values of 0.05V, 0.3V and 0.7V for the prior art oxygen electrode (without MPL 115). These results indicate that the MPL components improve the distribution of gases and liquids (e.g., because of their chemical properties) through the region governed by mass transport, e.g., due to forming of continuous paths for electric current through substrate 110, without disruptions. The results may also indicate that the oxygen electrode with MPL 115 prevents reverse currents. The graph represents a typical single run of a fuel cell with the oxygen electrode.

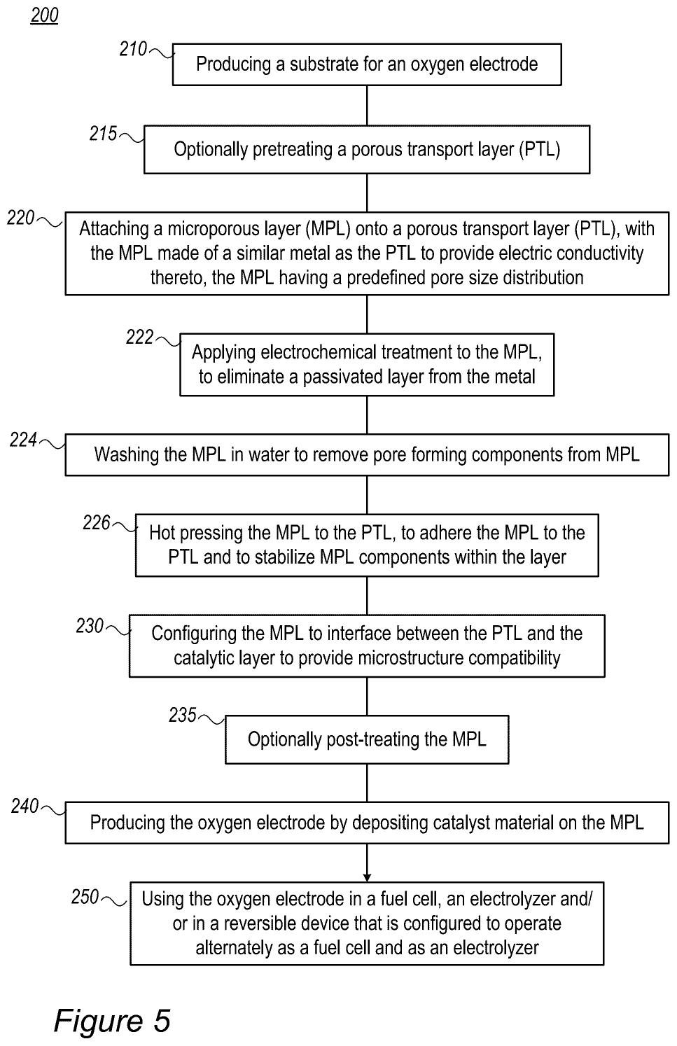

FIG. 5 is a high-level flowchart illustrating a method 200, according to some embodiments of the invention. The method stages may be carried out with respect to substrate 110 and/or oxygen electrode 100 described above, which may optionally be configured to implement method 200. Method 200 may comprise the following stages, irrespective of their order.

Method 200 comprises producing a substrate for an oxygen electrode (stage 210) by attaching a microporous layer (MPL) onto a porous transport layer (PTL), wherein the MPL is made of a similar metal as the PTL to provide electric conductivity thereto, and wherein the MPL has a predefined pore size distribution (stage 220). Method 200 may comprise configuring the MPL to interface between the PTL and the catalytic layer to provide microstructure compatibility (stage 230), as explained above.

In some embodiments, method 200 may comprise pretreating the PTL by various pretreatment methods (stage 215), such as chemical pretreatment (e.g., using acid), pretreatment by applying plasma, corona pretreatment, electrochemical pretreatment and/or mechanical pretreatment, etc.

Method 200 may comprise applying electrochemical treatment to the MPL, to eliminate a passivated layer from the metal (stage 222), washing the MPL in water to remove pore forming components from MPL (stage 224) and/or hot pressing the MPL to the PTL, to adhere the MPL to the PTL and to stabilize MPL components within the layer (stage 226).

In some embodiments, method 200 may comprise post-treating the MPL (stage 235), e.g., chemically, to remove (e.g., wash or dissolve) or modify components of the MPL. In some embodiments, post-treatment 235 may be applied by sintering.

Method 200 may further comprise producing the oxygen electrode by depositing catalyst material on the MPL (stage 240) and/or using the oxygen electrode in a fuel cell, an electrolyzer and/or in a reversible device that is configured to operate alternately as a fuel cell and as an electrolyzer (stage 250).

Elements from FIGS. 1-5 may be combined in any operable combination, and the illustration of certain elements in certain figures and not in others merely serves an explanatory purpose and is non-limiting.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A substrate for producing an oxygen electrode, the substrate comprising:
a porous transport layer (PTL) made of metal fibers comprising at least one of nickel, stainless steel, titanium, alloys thereof or combinations thereof, and
a microporous layer (MPL) made of a similar metal as the PTL, attached to the PTL to provide electric conductivity thereto, and to yield a predefined pore size distribution of the substrate.

2. The substrate of claim 1, post treated to eliminate a passivated layer from the metal, to remove pore forming components from MPL, to adhere the MPL to the PTL and/or to stabilize MPL components within the layer.

3. The substrate of claim 1, wherein the MPL is attached to the PTL by printing or spraying, optionally further applying hot pressing, calendaring or roll pressing.

4. The substrate of claim 1, further comprising pre-treating the PTL before attaching the MPL thereto.

5. The substrate of claim 1, further comprising post-treating the MPL after attaching the MPL to the PTL.

6. An oxygen electrode comprising catalyst material deposited on the MPL of the substrate of claim 1.

7. A fuel cell comprising a hydrogen electrode, a membrane, electrolyte and the oxygen electrode of claim 6.

8. An electrolyzer comprising a hydrogen electrode, a membrane, electrolyte and the oxygen electrode of claim 6.

9. A reversible device, configured to operate alternately as a fuel cell and as an electrolyzer, the reversible device comprising a hydrogen electrode, a membrane, electrolyte and the oxygen electrode of claim 6.

10. A method comprising producing a substrate for an oxygen electrode by attaching a microporous layer (MPL) onto a porous transport layer (PTL), wherein the MPL is made of a similar metal as the PTL to provide electric conductivity thereto, and wherein the MPL has a predefined pore size distribution.

11. The method of claim 10, wherein the MPL is attached to the PTL by printing or spraying, optionally further applying hot pressing, calendaring or roll pressing.

12. The method of claim 10, further comprising applying electrochemical treatment to the MPL, to eliminate a passivated layer from the metal.

13. The method of claim 10, further comprising washing the MPL in water to remove pore forming components from MPL.

14. The method of claim 10, further comprising pre-treating the PTL before attaching the MPL thereto.

15. The method of claim 10, further comprising post-treating the MPL after attaching the MPL to the PTL.

16. The method of claim 10, further comprising hot pressing the MPL to the PTL, to adhere the MPL to the PTL and to stabilize MPL components within the layer.

17. The method of claim 10, further comprising producing the oxygen electrode by depositing catalyst material on the MPL.

18. The method of claim 17, further comprising using the oxygen electrode in a fuel cell, an electrolyzer and/or in a reversible device that is configured to operate alternately as a fuel cell and as an electrolyzer.
